(19) United States
(12) Patent Application Publication
(10) Pub. No.: US 2021/0185313 A1
(43) Pub. Date: Jun. 17, 2021

(54) RESIDUAL METRICS IN ENCODER RATE CONTROL SYSTEM

(71) Applicant: ATI Technologies ULC, Markham (CA)

(72) Inventors: Boris Ivanovic, Richmond Hill (CA); Mehdi Saeedi, Thornhill (CA)

(21) Appl. No.: 16/715,187

(22) Filed: Dec. 16, 2019

(51) Int. Cl. H04N 19/115; G06N 5/04; H04N 19/176; H04N 19/159

(52) U.S. Cl. CPC H04N 19/115; H04N 19/159; H04N 19/176; G06N 5/04

(57) ABSTRACT

Systems, apparatuses, and methods for using residual metrics for encoder rate control are disclosed. An encoder includes a mode decision unit for determining a mode to be used for generating a predictive block for each block of a video frame. For each block, control logic calculates a residual of the block by comparing an original version of the block to the predictive block. The control logic generates a residual metric based on the residual and based on the mode. The encoder's rate controller selects a quantization strength setting for the block based on the residual metric. Then, the encoder generates an encoded block that represents the input block by encoding the block with the selected quantization strength setting. Next, the encoder conveys the encoded block to a decoder to be displayed. The encoder repeats this process for each block of the frame.

### BACKGROUND

### Description of the Related Art

Various applications perform encoding and decoding of images or video content. For example, video transcoding, desktop sharing, cloud gaming, and gaming spectatorship are some of the applications which include support for encoding and decoding of content. Increasing quality demands and higher video resolutions require ongoing improvements to encoders. When an encoder operates on a frame of a video sequence, the frame is typically partitioned into a plurality of blocks. Examples of blocks include a coding tree block (CTB) for use with the high efficiency video coding (HEVC) standard or a macroblock for use with the H.264 standard. Other types of blocks for use with other types of standards are also possible.

For the different video compression algorithms, blocks can be broadly generalized as falling into one of three different types: I-blocks, P-blocks, and skip blocks. It should be understood that other types of blocks can be used in other video compression algorithms. As used herein, an intra-block (or “I-block”) is or “Intra-block” is a block that depends on blocks from the same frame. A predicted-block (“P-block”) is defined as a block within a predicted frame (“P-frame”), where the P-frame is defined as a frame which is based on previously decoded pictures. A “skip block” is defined as a block which is relatively (based on a threshold) unchanged from a corresponding block in a reference frame. Accordingly, a skip block generally requires a very small number of bits to encode.

An encoder typically has a target bitrate which the encoder is trying to achieve when encoding a given video stream. The target bitrate roughly translates to a target average bitsize for each frame of the encoded version of the given video stream. For example, in one implementation, the target bitrate is specified in bits per second (e.g., 3 megabits per second (Mbps)) and a frame rate of the video sequence is specified in frames per second (fps) (e.g., 60 fps, 24 fps). In this example implementation, the preferred bit rate is divided by the frame rate to calculate a preferred bitsize of the encoded video frame if a linear bitsize trajectory is assumed. For other trajectories, a similar approach can be taken.

In video encoders, a rate controller adjusts quantization (e.g., quantization parameter (QP)) based on how far rate control is either under-budget or over-budget. A typical encoder rate controller uses a budget trajectory to determine whether an over-budget or under-budget condition exists. The rate controller adjusts QP in the appropriate direction proportionally to the discrepancy. Common video encoders expect QP to converge, but this may not occur quickly in practice. In many cases, the video content changes faster than QP converges. Therefore, a non-optimal QP value is used much of the time during encoding, leading to both reduced quality and increased bit-rate.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a system for encoding and decoding content.

FIG. 2 is a diagram of one possible example of a frame being encoded by an encoder.

FIG. 3 is a block diagram of one implementation of an encoder.

FIG. 4 is a block diagram of one implementation of a rate controller for use with an encoder.

FIG. 5 is a generalized flow diagram illustrating one implementation of a method for predicting block types by a pre-encoder.

FIG. 6 is a generalized flow diagram illustrating one implementation of a method for tuning a residual metric generation unit.

FIG. 7 is a generalized flow diagram illustrating one implementation of a method for selecting a quantization parameter (QP) to use for a block being encoded.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for using residual metrics for encoder rate control are disclosed herein. In one implementation, a new variable, a residual metric, is calculated by an encoder to allow better quantization parameter (QP) selection as content changes. As used herein, the term “residual” is defined as the difference between the original version of a block and the predictive version of the block generated by the encoder. The use of the residual metric creates the potential for improved convergence, rate control, and bit allocation. Pre-analysis units can consider the complexity of the data in the block to affect QP control. However, the block complexity does not always correlate to the final encoded size, especially when encoder tools allow for good intra-prediction and inter-prediction. In many cases, the complexity of the residual will correlate to the final encoded size. In one implementation, the encoder includes control logic that calculates a metric on the residual, which is the actual data to be encoded. The residual is the difference between the values of an original block and values of a predictive block generated based on the original block by the encoder. For example, the predictive block may include values reflecting changes over time (e.g. due to motion) in an image that causes values in the original block to change from a first value to a second value. The “predictive block” can be generated using spatial and/or temporal prediction. The above approach takes advantage of the correlation between the complexity of the residual and the final encoded size. Accordingly, by using the residual metric to influence QP selection, better rate control and more efficient use of bits can be achieved by the encoder.

In one implementation, an encoder includes a mode decision unit for determining a mode to be used for encoding each block of a video frame. For each block, the encoder calculates a residual of the block by comparing an original version of the block to a predicted version of the block. The encoder generates a residual metric based on the residual and based on the mode. The encoder's rate controller selects a quantization strength setting for the block based on the residual metric. Then, the encoder generate an encoded block that represents the input block by encoding the block with the selected quantization strength setting. Next, the encoder conveys the encoded block to a decoder to be displayed. The encoder repeats this process for each block of the frame.

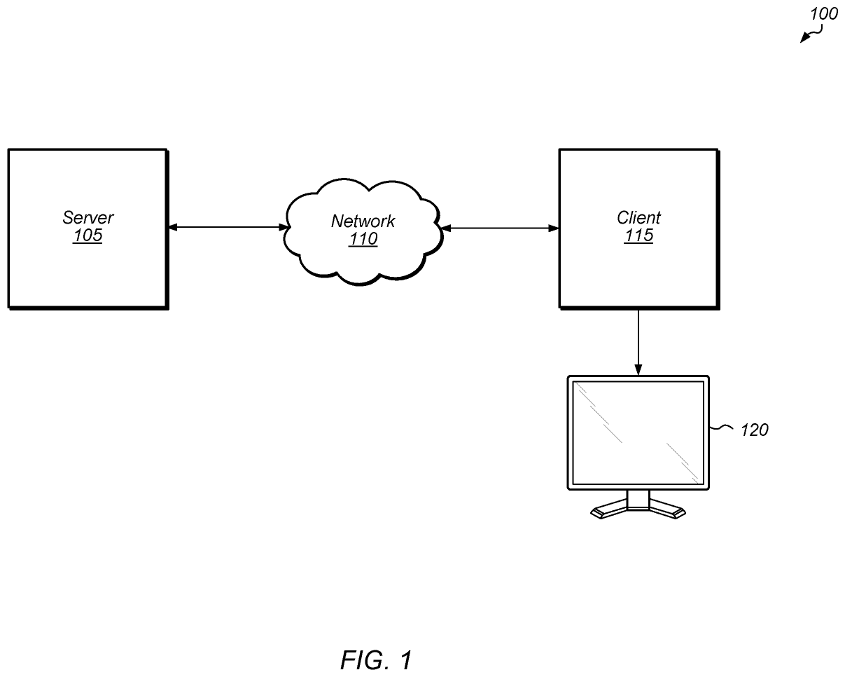

Referring now to FIG. 1, a block diagram of one implementation of a system 100 for encoding and decoding content is shown. System 100 includes server 105, network 110, client 115, and display 120. In other implementations, system 100 includes multiple clients connected to server 105 via network 110, with the multiple clients receiving the same bitstream or different bitstreams generated by server 105. System 100 can also include more than one server 105 for generating multiple bitstreams for multiple clients.

In one implementation, system 100 encodes and decodes video content. In various implementations, different applications such as a video game application, a cloud gaming application, a virtual desktop infrastructure application, a screen sharing application, or other types of applications are executed by system 100. In one implementation, server 105 renders video or image frames and then encodes the frames into an encoded bitstream. Server 105 includes an encoder with a residual metric generation unit to adaptively adjust quantization strength settings used for encoding blocks of frames. In one implementation, the quantization strength setting refers to a quantization parameter (QP). It should be understood that when the term QP is used within this document, this term is intended to apply to other types of quantization strength metrics that are used with any type of coding standard.

In one implementation, the residual metric generation unit receives a mode decision and a residual for each block, and the residual metric generation unit generates one or more residual metrics for each block based on the mode decision and the residual for the block. Then, a rate controller unit generates a quantization strength setting for each block based on the one or more residual metrics for the block. As used herein, the term “residual” is defined as the difference between the original version of the block and the predictive version of the block generated by the encoder. Still further, as used herein, the term “mode decision” is defined as the prediction type (e.g., intra-prediction, inter-prediction) that will be used for encoding the block by the encoder. By selecting a quantization strength setting that is adapted to each block based on the mode decision and the residual, the encoder is able to encode the blocks into a bitstream that meets a target bitrate while also preserving a desired target quality for each frame of a video sequence. After the encoded bitstream is generated, server 105 conveys the encoded bitstream to client 115 via network 110. Client 115 decodes the encoded bitstream and generates video or image frames to drive to display 120 or to a display compositor.

Network 110 is representative of any type of network or combination of networks, including wireless connection, direct local area network (LAN), metropolitan area network (MAN), wide area network (WAN), an Intranet, the Internet, a cable network, a packet-switched network, a fiber-optic network, a router, storage area network, or other type of network. Examples of LANs include Ethernet networks, Fiber Distributed Data Interface (FDDI) networks, and token ring networks. In various implementations, network 110 includes remote direct memory access (RDMA) hardware and/or software, transmission control protocol/internet protocol (TCP/IP) hardware and/or software, router, repeaters, switches, grids, and/or other components.

Server 105 includes any combination of software and/or hardware for rendering video/image frames and encoding the frames into a bitstream. In one implementation, server 105 includes one or more software applications executing on one or more processors of one or more servers. Server 105 also includes network communication capabilities, one or more input/output devices, and/or other components. The processor(s) of server 105 include any number and type (e.g., graphics processing units (GPUs), central processing units (CPUs), digital signal processors (DSPs), field programmable gate arrays (FPGAs), application specific integrated circuits (ASICs)) of processors. The processor(s) are coupled to one or more memory devices storing program instructions executable by the processor(s). Similarly, client 115 includes any combination of software and/or hardware for decoding a bitstream and driving frames to display 120. In one implementation, client 115 includes one or more software applications executing on one or more processors of one or more computing devices. In various implementations, client 115 is a computing device, game console, mobile device, streaming media player, or other type of device.

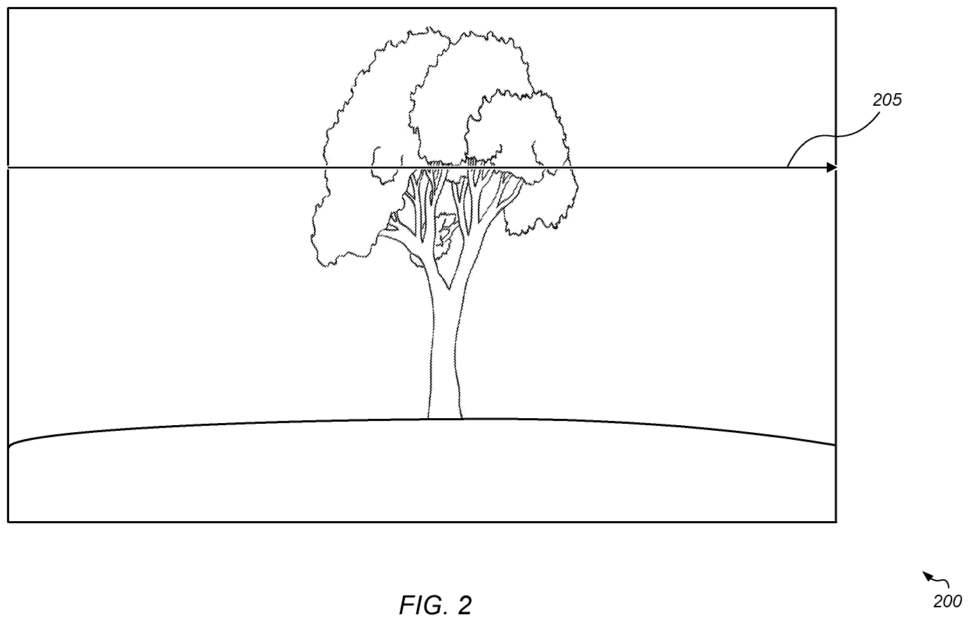

Turning now to FIG. 2, a diagram of one possible example of a frame 200 being encoded by an encoder is shown. A typical hardware encoder rate control system uses a budget trajectory to determine the over-budget or under-budget condition, adjusting the quantization parameter (QP) in the appropriate direction proportionally to the discrepancy. The QP is expected to converge within the frame. In many cases, the content can change faster than the rate of rate control convergence.

As an example of a typical encoder rate control system, if an encoder is encoding frame 200 along horizontal line 205, there is drastically different content as the encoder moves along horizontal line 205. Initially, the macroblocks have pixels representing a sky as the encoder moves from the left edge of frame 200 to the right. The encoder will likely be increasing the quality used to encode the macroblocks since these macroblocks showing the sky can be encoded with a relatively low number of bits. Then, after several macroblocks of sky, the content transitions to a tree. With the quality set to a high value for the sky, when the scene transitions to the tree, the number of bits used to encode the first macroblock containing a portion of the tree will be relatively high due to the high amount of spatial detail in this block. Accordingly, at the transition from sky to trees, the encoder's rate control mechanism could require significant time to converge. The encoder will eventually reduce the quality used to encode the macroblocks with trees to reduce the number of bits that are generated for the encoded versions of these blocks.

Then, when the scene transitions back to the sky again along horizontal line 205, the encoder will have a relatively low quality setting for encoding the first block containing the sky after the end of the tree scenery. This will result in a much lower number of bits for this first block containing sky than the encoder would typically use. As a result of using the low number of bits for this block, the encoder will increase the quality used to encode the next macroblock of sky, but the transition again could take significant time to converge. These transitions caused by having different content spread throughout a frame results in both reduced perceptual quality and increased bit rate. In other words, bits are used to show features which are relatively unimportant, resulting in a sub-optimal mix of bits according to the importance of the scenery in terms of what the user will observe as perceptually important.

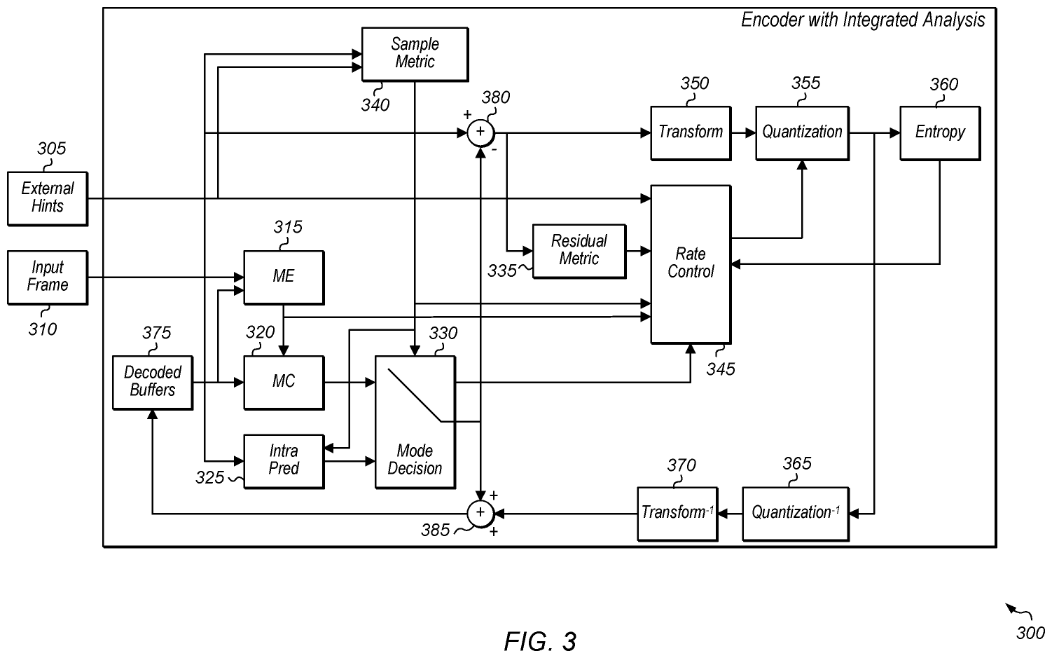

Referring now to FIG. 3, a block diagram of one implementation of an encoder 300 is shown. In one implementation, encoder 300 receives input frame 310 to be encoded into an encoded frame. In one implementation, input frame 310 is generated by a rendering application. For example, input frame 310 can be a frame rendered as part of a video game application. Other applications for generating input frame 310 are possible and are contemplated.

Input frame 310 is coupled to motion estimation (ME) unit 315, motion compensation (MC) unit 320, intra-prediction unit 325, and sample metric unit 340. ME unit 315 and MC unit 320 generate motion estimation data (e.g., motion vectors) for input frame 310 by comparing input frame 310 to decoded buffers 375, with decoded buffers 375 storing one or more previous frames. ME unit 315 uses motion data, including velocities, vector confidence, local vector entropy, etc. to generate the motion estimation data. MC unit 320 and intra-prediction unit 325 provide inputs to mode decision unit 330. Also, sample metric 340 provides inputs to mode decision unit 330. Sample metric unit 340 examines samples from input frame 310 and one or more previous frames to generate complexity metrics such as gradients, variance metrics, a GLCM, entropy values, and so on.

In one implementation, mode decision unit 330 determines the mode for generating predictive blocks on a block-by-block basis depending on the inputs received from MC unit 320, intra-prediction unit 325, and sample metric unit 340. For example, different types of modes selected by mode decision unit 330 for generating a given predictive block of input frame 310 include intra-prediction mode, inter-prediction mode, and gradient mode. In other implementations, other types of modes can be used by mode decision unit 330. The mode decision generated by mode decision unit 330 is forwarded to residual metric unit 335, rate controller unit 345, and comparator 380.

In one implementation, comparator 380 generates the residual which is the difference between the current block of input frame 310 and the predictive version of the block generated based on the mode decision. In one implementation, the predictive version of the block is generated based on any suitable combination of spatial and/or temporal prediction. In another implementation, the predictive version of the block is generated using a gradient, a specific pattern (e.g., stripes), a solid color, one or more specific objects or shapes, or using other techniques. The residual generated by comparator 380 is provided to residual metric unit 335. In one implementation, the residual is an N×N matrix of pixel difference values, where N is a positive integer and N is equal to the dimension of the macroblock for a particular video or image compression algorithm.

Residual metric unit 335 generates one or more residual metrics based on the residual, and the one or more residual metrics are provided to rate controller unit 345 to help in determining the QP to use for encoding the current block of input frame 310. In one implementation, the term “residual metric” is defined as a complexity estimate of the current block, with the complexity estimate correlated to QP. In one implementation, the inputs to residual metric unit 335 are the residual for the current block and the mode decision, which can affect the metric calculations. The output of residual metric unit 335 can be a single value or multiple values. Metric calculations that can be employed include entropy, gradient, variance, gray-level co-occurrence matrix (GLCM), or multi-scale metric.

For example, in one implementation, a first residual metric is a measure of the entropy in the residual matrix. In one implementation, the first residual metric is the sum of absolute differences between the pixels of the current block of input frame 310 and the pixels of the predictive version of the block generated based on the mode decision. In another implementation, a second residual metric is a measure of the visual significance contained in the values of the residual matrix. In other implementations, other residual metrics can be generated. As used herein, the term “visual significance” is defined as a measure of the importance of the residual in terms of the capabilities of the human psychovisual system or how humans perceive visual information. In some cases, a measure of entropy of the residual does not precisely measure the importance of the residual as perceived by a user. Accordingly, in one implementation, the visual significance of the residual is calculated by applying one or more correction factors to the entropy of the residual. For example, the entropy of the residual in a dark area can be more visually significant than a light area. In another example, the entropy of the residual in a stationary area can be more visually significant than in a moving area. In a further example, a first correction factor is based on the electro-optical transfer function (EOTF) of the target display, and the first correction factor is applied to the entropy to generate the visual significance. Alternatively, in another implementation, the visual significance of the residual is calculated separately from the entropy of the residual. It is noted that residual metric unit 335 calculates the one or more residual metrics before the transform is performed on the current block. It is also noted that residual metric unit 335 can be implemented using any combination of control logic and/or software.

In one implementation, the desired QP for encoding the current block is provided to transform unit 350 by rate controller unit 345, and the desired QP is forwarded by transform unit to quantization unit 355 along with the output of transform unit 350. The output of quantization unit 355 is coupled to both entropy unit 360 and inverse quantization unit 365. Inverse quantization unit 365 reverses the quantization step performed by quantization unit 355. The output of inverse quantization unit 365 is coupled to inverse transform unit 370 which reverses the transform step performed by transform unit 350. The output of inverse transform unit 370 is coupled to a first input of adder 385. The predictive version of the current block generated by mode decision unit 330 is coupled to a second input of adder 385. Adder 385 calculates the sum of the output of inverse transform unit 370 with the predicted version of the current block, and the sum is stored in decoded buffers 375.

In addition to the previously described blocks of encoder 300, external hints 305 represent various hints that can be provided to encoder 300 to enhance the encoding process. For example, external hints 305 can include user-provided hints for a region of pixels such as a region of interest, motion vectors from a game engine, data derived from rendering (e.g., derived from a game's geometry-buffer, motion, or other available data), and text/graphics areas. Other types of external hints can be generated and provided to encoder 300 in other implementations. It should be understood that encoder 300 is representative of one type of structure for implementing an encoder. In other implementations, other types of encoders with other components and/or structured in other suitable manners can be employed.

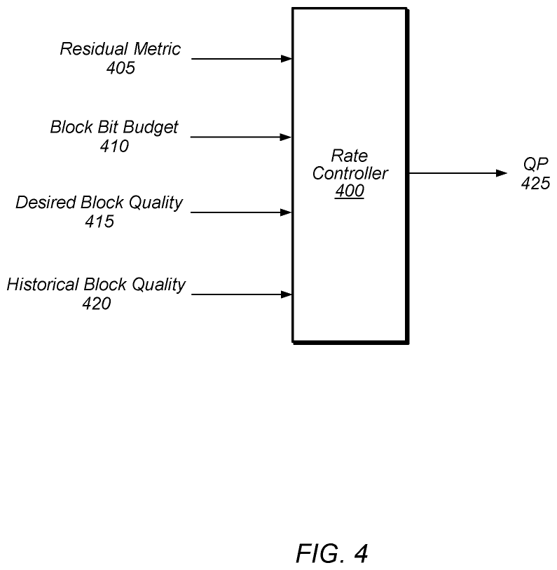

Turning now to FIG. 4, a block diagram of one implementation of a rate controller 400 for use with an encoder is shown. In one implementation, rate controller 400 is part of an encoder (e.g., encoder 300 of FIG. 3) for encoding frames of a video stream. As shown in FIG. 4, rate controller 400 receives a plurality of values which are used to influence the decision that is made when generating a quantization parameter (QP) 425 for encoding a given block. In one implementation, the plurality of values include residual metric 405, block bit budget 410, desired block quality 415, and historical block quality 420. It is noted that rate controller 400 can receive these values for each block of a frame being encoded. Rate controller 400 uses these values when determining how to calculate the QP 425 for encoding a given block of the frame.

In one implementation, residual metric 405 serves as a complexity estimate of the current block. In one implementation, residual metric 405 is correlated to QP using machine learning, least squares regression, or other models. In various implementations, block bit budget 410 is initially determined using linear budgeting, pre-analysis, multi-pass encoding, and/or historical data. In one implementation, block bit budget 410 is adjusted on the fly if meeting the local global budget is determined to be in jeopardy. In other words, block bit budget 410 is adjusted using the current budget miss or surplus. Block bit budget 410 serves to constrain rate controller 400 to the required budget.

Depending on the implementation, desired bit quality 415 can be expressed in terms of mean squared error (MSE), peak signal-to-noise ratio (PSNR), or other perceptual metrics. Desired bit quality 415 can originate from the user or from content pre-analysis. Desired bit quality 415 serves as the target quality of the current block. In some cases, rate controller 400 can also receive a maximum target bit quality to avoid spending excessive bits on quality for the current block. In one implementation, historical block quality 420 is a quality measure of a co-located block or a block that contains the same object as the current block. Historical block quality 420 bounds the temporal quality changes for the blocks of the frame being rendered.

In one implementation, rate controller 400 uses a model to determine QP 425 based on residual metric 405, block bit budget 410, desired block quality 415, and historical block quality 420. The model can be a regressive model, use machine learning, or be based on other techniques. In one implementation, the model is used for each block in the picture. In another implementation, the model is only used when content changes, with conventional control used within similar content areas. The priority of each of the stimuli or constraints can be determined by the use case. For example, if the budget must be strictly met, the constraint of meeting the block bit budget would have a higher priority than meeting the desired quality. In one example, when a specific bit size and/or quality level is required, a random forest regressor is used to model QP.

The traditional encoding rate control methods try to adjust QP in a reactive fashion, but convergence rarely occurs as QP is content dependent and the content is always changing. With conventional encoding schemes, rate control is chasing a moving target. This results in compromise to both quality and bit rate. In other words, for the conventional encoding scheme, the budget trajectory is usually wrong to some extent. The mechanisms and methods introduced herein introduce an additional variable for better control and for better recovery. These mechanisms and methods prevent over-budget situations from unnecessarily wasting bits and allow savings to be used for recovery in under budgeted areas. For example, for an encoder, a seemingly complex block of an input frame can be trivial to encode with the appropriate inter-prediction or intra-prediction. However, pre-analysis units do not detect this since pre-analysis units do not have access to mode decision, motion vectors, and intra-predictions or inter-predictions since these decisions are made after the pre-analysis step.

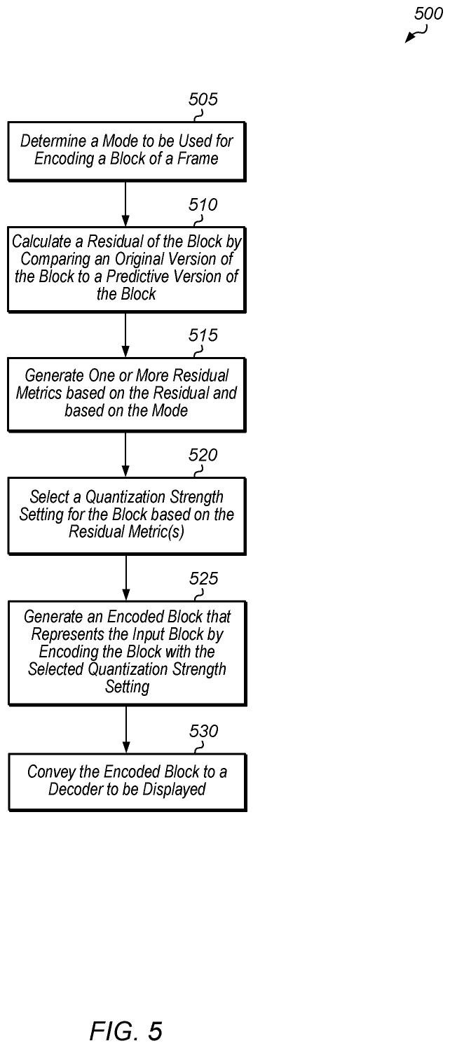

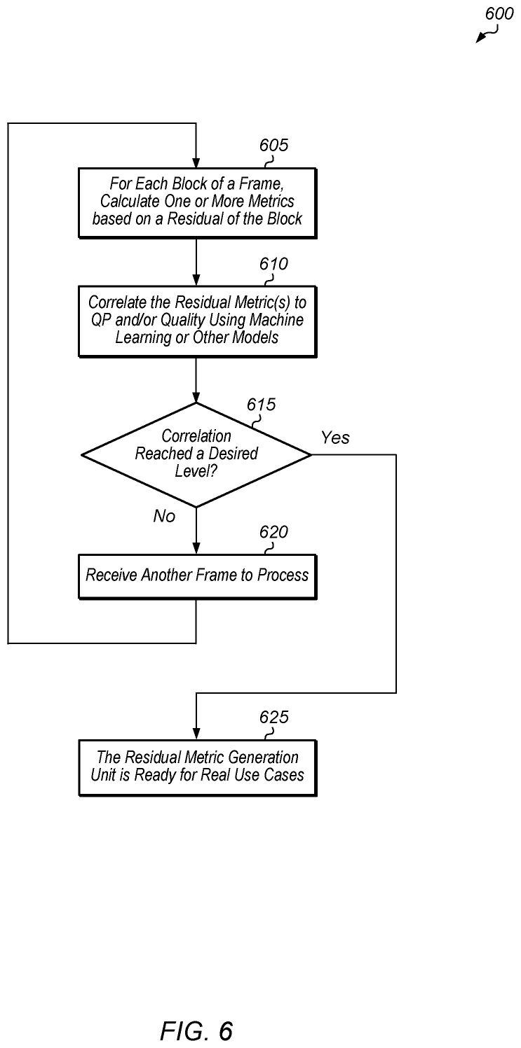

Referring now to FIG. 5, one implementation of a method 500 for performing rate control in an encoder based on residual metrics is shown. For purposes of discussion, the steps in this implementation and those of FIG. 6 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 500.

A mode decision unit determines a mode (e.g., intra-prediction mode, inter-prediction mode) to be used for encoding a block of a frame (block 505). Also, control logic calculates a residual of the block by comparing an original version of the block to a predictive version of the block (block 510). Next, the control logic generates one or more residual metrics based on the residual and based on the mode (block 515).

Then, a rate controller unit selects a quantization strength setting for the block based on the residual metric(s) (block 520). Next, an encoder generates an encoded block that represents the input block by encoding the block with the selected quantization strength setting (block 525). Then, the encoder conveys the encoded block to a decoder to be displayed (block 530). After block 530, method 500 ends. It is noted that method 500 can be repeated for each block of the frame.

Turning now to FIG. 6, one implementation of a method 600 for tuning a residual metric generation unit is shown. For each block of a frame, a residual metric generation unit (e.g., residual metric unit 335 of FIG. 3) calculates one or more metrics based on a residual of the block (block 605). Next, the residual metric(s) are correlated to QP and/or quality. In various embodiments, any of a variety of approaches to correlating the residual metrics to QP and/or quality are used, for example machine learning or other models (block 610) can be used. If the correlation between the residual metric(s) and QP and/or quality has not reached the desired level (conditional block 615, “no” leg), then the residual metric generation unit receives another frame to process (block 620), and method 600 returns to block 605. Otherwise, if the correlation between the residual metric(s) and QP and/or has reached a desired level (conditional block 615, “yes” leg), then the residual metric generation unit is ready to be employed for real use cases (block 625). After block 625, method 600 ends. Using method 600 ensures that the encoder does not exceed the quality target, leaving bits for when they truly needed, such as later in the picture or scene.

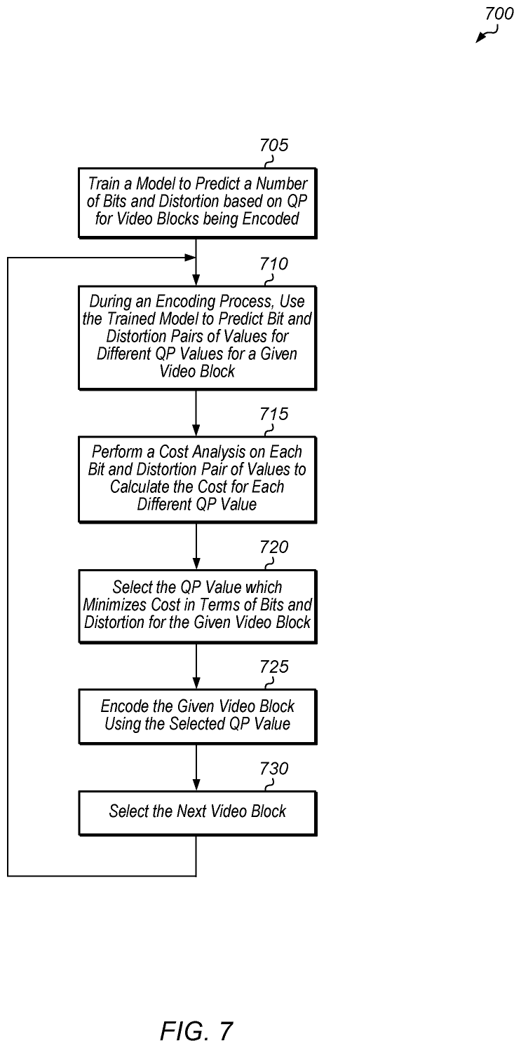

Referring now to FIG. 7, one implementation of a method 700 for selecting a quantization parameter (QP) to use for a block being encoded is shown. A model is trained to predict a number of bits and distortion based on QP for video blocks being encoded (block 705). In one implementation, residuals for some number of video clips are available as well as the predicted bits and distortion values for the blocks of the video clips based on different QP values being used to encode the blocks. In one implementation, the model is trained based on the residuals and the predicted bits and distortion values for different QP values. Next, during an encoding process, the trained model predicts bit and distortion pairs of values for different QP values for a given video block (block 710). A cost analysis is performed on each bit and distortion pair of values to calculate the cost for each different QP value (block 715). For example, the cost is calculated based on how many bits are predicted to be generated for the encoded block and based on how much distortion is predicted for the encoded block. Then, the QP value which minimizes cost in terms of bits and distortion is selected for the given video block (block 720). In one implementation, the residual of the given video block is provided as an input to the model and the output of the model is the QP that will result in a lowest possible cost for the given video block as compared to the costs associated with other QP values. In another implementation, the residual is provided as an input to a lookup table and the output of the lookup table is the QP with the lowest cost. Next, the given video block is encoded using the selected QP value (block 725). After block 725, the next video block is selected (block 730), and then method 700 returns to block 710.

In various implementations, program instructions of a software application are used to implement the methods and/or mechanisms described herein. For example, program instructions executable by a general or special purpose processor are contemplated. In various implementations, such program instructions can be represented by a high level programming language. In other implementations, the program instructions can be compiled from a high level programming language to a binary, intermediate, or other form. Alternatively, program instructions can be written that describe the behavior or design of hardware. Such program instructions can be represented by a high-level programming language, such as C. Alternatively, a hardware design language (I L) such as Verilog can be used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

1. A system comprising:
control logic configured to:
calculate a residual of a block by comparing an original version of the block to a predictive block; and
generate a residual metric based on, and distinct from, the residual;
a rate controller unit configured to select a quantization strength setting for the block based on the residual metric; and
an encoder configured to:
generate an encoded block by encoding the block with the selected quantization strength setting.

2. The system as recited in claim 1, wherein the rate controller unit is further configured to:
receive a block bit budget, desired block quality, historical block quality, and the residual metric; and
select the quantization strength setting for the block based on the residual metric, block bit budget, desired block quality, and historical block quality.

3. The system as recited in claim 1, wherein the predictive block is generated from a block in a previous frame.

4. The system as recited in claim 1, wherein the predictive block is generated based on a gradient.

5. The system as recited in claim 1, wherein the residual is an N-by-N matrix of pixel difference values between the original version of the block and the predictive block, wherein N is a positive integer.

6. The system as recited in claim 1, wherein the residual metric is a complexity estimate of the block.

7. The system as recited in claim 1, wherein the residual metric is generated in further response to either an intra-prediction mode or an inter-prediction mode for generating the predictive block.

8. A method comprising:
calculating, by control logic, a residual of a block by comparing an original version of the block to a predictive block;
generating, by the control logic, a residual metric based on, and distinct from, the residual;
selecting, by a rate controller unit, a quantization strength setting for the block based on the residual metric;
generating, by an encoder, an encoded block by encoding the block with the selected quantization strength setting; and
conveying, by the encoder, the encoded block to a decoder to be displayed.

9. The method as recited in claim 8, further comprising:
receiving, by the rate controller unit, a block bit budget, desired block quality, historical block quality, and the residual metric; and
selecting, by the rate controller unit, the quantization strength setting for the block based on the residual metric, block bit budget, desired block quality, and historical block quality.

10. The method as recited in claim 8, wherein the predictive block is generated from a block in a previous frame.

11. The method as recited in claim 8, wherein the predictive block is generated based on a gradient.

12. The method as recited in claim 8, wherein the residual is an N-by-N matrix of pixel difference values between the original version of the block and the predictive block, wherein N is a positive integer.

13. The method as recited in claim 8, wherein a first the residual metric is a complexity estimate of the block.

14. The method as recited in claim 8, further comprising selecting, by the mode decision unit, either an intra-prediction mode or an inter-prediction mode for generating the predictive block.

15. An apparatus comprising:
a memory; and
an encoder coupled to the memory, wherein the encoder is configured to:
calculate a residual of a block by comparing an original version of the block to a predictive block to be used for encoding a block of a frame;
generate a residual metric based on, and distinct from, the residual;
select a quantization strength setting for the block based at least in part on the residual metric; and
generate an encoded block by encoding the block with the selected quantization strength setting.

16. The apparatus as recited in claim 15, wherein the encoder is further configured to:
receive a block bit budget, desired block quality, historical block quality, and the residual metric; and
select the quantization strength setting for the block based on the residual metric, block bit budget, desired block quality, and historical block quality.

17. The apparatus as recited in claim 15, wherein the predictive block is generated from a block in a previous frame.

18. The apparatus as recited in claim 15, wherein the predictive block is generated based on a gradient.

19. The apparatus as recited in claim 15, wherein the residual is an N-by-N matrix of pixel difference values between the original version of the block and the predictive block, wherein N is a positive integer.

20. The apparatus as recited in claim 15, wherein the residual metric is a complexity estimate of the block.
